(19) United States
(12) Patent Application Publication
(10) Pub. No.: US 2010/0216018 A1
(43) Pub. Date: Aug. 26, 2010

(54) HYDROGEN-ABSORBING ALLOY AND ALKALINE STORAGE BATTERY HAVING THE ALLOY

(75) Inventors: Shigekazu Yasuoka, Takasaki-shi (JP); Yoshifumi Magari, Itano-gun (JP); Tadayoshi Tanaka, Osaka (JP); Masaru Kihara, Takasaki-shi (JP); Takahiro Endo, Takasaki-shi (JP); Akira Saguchi, Takasaki-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD., Osaka (JP)

(21) Appl. No.: 12/706,955

(22) Filed: Feb. 17, 2010

(30) Foreign Application Priority Data
Feb. 25, 2009 (JP) 2009-041703
Nov. 25, 2009 (JP) 2009-266994

(51) Int. Cl. H01M 10/26; C22C 19/03

(52) U.S. Cl. 429/206; 420/455

(57) ABSTRACT

A hydrogen-absorbing alloy is represented by the general formula Ln₁₋ₓMgₓNi_{y-a-b}AlₐM_{b} (where Ln is at least one element selected from the rare-earth elements, Zr, Ti, and Y, M is at least one element selected from the group consisting of V, Nb, Ta, Cr, Mo, Mn, Fe, Co, Ga, Zn, Sn, In, Cu, Si, P, B, and Zr, 0.05≦x≦0.35, 0.05≦a≦0.30, 0≦b≦0.5, and 2.5≦y<3.3). The Ln in the general formula includes Sm as its main component, and the hydrogen-absorbing alloy has an electrochemical capacity of 300 mAh/g or greater. An alkaline storage battery containing a negative electrode containing the hydrogen absorbing alloy.

### BACKGROUND OF THE INVENTION

1. Field of the Invention

The present invention relates to a hydrogen-absorbing alloy and an alkaline storage battery having the alloy in the negative electrode. The present invention also relates to an alkaline storage battery that achieves excellent cycle life.

2. Description of Related Art

Conventionally, nickel-cadmium storage batteries have been widely used as alkaline storage batteries. In recent years, nickel-metal hydride storage batteries using hydrogen-absorbing alloy as a material for the negative electrode have drawn considerable attention, from the viewpoints that they achieve higher capacity than nickel-cadmium storage batteries and that they are environmentally safer since they do not contain cadmium. Recently, the market for the nickel-metal hydride storage batteries has been expanding as they are secondary batteries that replace dry batteries.

In the nickel-metal hydride storage batteries, a rare earth-nickel hydrogen-absorbing alloy having a CaCu₅ type crystal structure as its main phase has generally been used as the hydrogen-absorbing alloy for the negative electrode. This hydrogen-absorbing alloy, however, does not necessarily have sufficient hydrogen-absorbing capability. Therefore, it has been difficult to further increase the capacity of the nickel-metal hydride storage batteries.

In view of the problem, it has been developed in recent years to provide a rare earth-Mg-Ni-based hydrogen absorbing alloy, which is made to have a Ce₂Ni₇ type crystal structure other than the CaCu₅ type as the main crystal structure, by adding Mg or the like to the above-described rare earth-Ni-based hydrogen absorbing alloy, in order to improve the hydrogen-absorbing capability of the rare earth-Ni-based hydrogen absorbing alloy, as disclosed in Patent Document 1 (Japanese Published Unexamined Patent Application No. 2005-226084).

The rare earth-Mg—Ni-based hydrogen absorbing alloy of Patent Document 1, however, has the following problem. Since it has a large electrochemical capacity, the alloy tends to crack during charge and discharge and the interior of the alloy becomes easily oxidized. As a consequence, the cycle life of the battery containing this alloy tends to degrade.

### BRIEF SUMMARY OF THE INVENTION

It is an object of the present invention to resolve the foregoing and other problems in the alkaline storage battery having a negative electrode containing a rare earth-Mg—Ni-based hydrogen absorbing alloy. The invention provides an alkaline storage battery that can inhibit oxidation of the hydrogen absorbing alloy and maintain a high capacity over a long period of time when the battery undergoes repeated charge-discharge cycles.

The present invention provides a hydrogen-absorbing alloy used for an alkaline storage battery comprising a positive electrode, a negative electrode containing the hydrogen-absorbing alloy, and an alkaline electrolyte solution, the hydrogen-absorbing alloy containing at least a rare-earth element, magnesium, nickel, and aluminum and being represented by the general formula Ln₁₋ₓMgₓNi_{y-a-b}AlₐM_{b} (where Ln is at least one element selected from Zr, Ti and the rare-earth elements including Y, M is at least one element selected from the group consisting of V, Nb, Ta, Cr, Mo, Mn, Fe, Co, Ga, Zn, Sn, In, Cu, Si, P, B, and Zr, 0.05≦x≦0.35, 0.05≦a≦0.30, 0≦b≦0.5, and 2.5≦y<3.3), wherein the Ln in the general formula comprises Sm as its main component, and the hydrogen-absorbing alloy has an electrochemical capacity of 300 mAh/g or greater.

The phrase “Ln comprises Sm as its main component” means that the proportion of Sm in Ln is 50 mole % or greater.

The hydrogen-absorbing alloy represented by the foregoing general formula has a different crystal structure from the conventional rare earth-Mg—Ni-based alloy having a Ce₂Ni₇ structure and shows an improved corrosion resistance. However, by merely reducing the proportion of Ni, the electrochemical capacity of the hydrogen-absorbing alloy decreases considerably, and additionally, the corrosion resistance degrades.

In the present invention, a rare earth component Sm is employed as the main component in the hydrogen-absorbing alloy. In addition, the parameter y in the general formula, that is, the B/A ratio, which is the stoichiometric ratio of the amount of (Ln+Mg) and the amount of (Ni+Al+M), is set to 2.5 or greater but less than 3.3, allowing the main crystal structure to change into a PuNi₃ structure or a CeNi₃ structure. Thereby, the charge-discharge operations can be performed stably, and at the same time, the oxidation of the hydrogen-absorbing alloy associated with charge and discharge can be inhibited. As a result, the cycle life of the battery is improved.

A hydrogen-absorbing alloy that has a PuNi₃ type crystal structure or a CeNi₃ type crystal structure may be capable of inhibiting oxidation of the hydrogen-absorbing alloy. Nevertheless, with the hydrogen-absorbing alloy, it is difficult to perform a stable charge-discharge reaction, in other words, it is difficult to cause hydrogen to be absorbed and desorbed in a stable condition. However, in the present invention, hysteresis is inhibited by employing Sm as the main component in Ln of the general formula. As a result, a stable charge-discharge reaction, in other words, a stable hydrogen absorption and desorption reaction, is made possible.

Nevertheless, even with a hydrogen-absorbing alloy having such a composition, a stable hydrogen absorption and desorption cannot be achieved if the hydrogen-absorbing alloy has an electrochemical capacity of less than 300 mAh/g. For this reason, the electrochemical capacity of the hydrogen-absorbing alloy is 300 mAh/g or greater in the present invention. As a result, the present invention makes available a hydrogen-absorbing alloy that is excellent in corrosion resistance and also an alkaline storage battery that can maintain a high capacity over a long period of time.

It is particularly preferable that the amount of Mg in the hydrogen-absorbing alloy be within the range of from 0.11 to 0.17. If the amount of Mg exceeds 0.17, the hydrogen-absorbing alloy tends to crack easily, and the corrosion resistance degrades. On the other hand, if the amount of Mg is less than 0.11, the electrochemical capacity is so small that the battery capacity cannot be increased.

### Advantageous Effects of the Invention

The alkaline storage battery of the present invention, which has the above-described hydrogen-absorbing alloy, is able to inhibit oxidation of the hydrogen-absorbing alloy even with repeated charge-discharge cycles, and shows improved corrosion resistance. In addition, it allows hydrogen absorption and desorption to be performed in a stable condition over a long period of time. Thus, the present invention makes available an alkaline storage battery that can inhibit the charge reserve of the negative electrode from decreasing and maintain a high capacity over a long period of time.

### BRIEF DESCRIPTION OF THE DRAWINGS

FIG. 1 is an X-ray diffraction profile of an example alloy 1 of the present invention; and FIG. 2 is a schematic view illustrating a three-electrode test cell fabricated in Examples and Comparative Examples of the present invention.

### DETAILED DESCRIPTION OF THE INVENTION

Hereinbelow, preferred embodiments of a hydrogen-absorbing alloy and an alkaline storage battery having the hydrogen-absorbing alloy according to the present invention will be described in detail. The hydrogen absorbing alloy and the alkaline storage battery according to the invention are not limited to those shown in the following examples, but various changes and modifications are possible without departing from the scope of the invention.

### Examples

Hereinbelow, examples of the hydrogen-absorbing alloy and the alkaline storage battery having the hydrogen-absorbing alloy according to the present invention are described in detail. It will be demonstrated that the examples of the hydrogen-absorbing alloy and the alkaline storage battery having the hydrogen-absorbing alloy can achieve significant improvements in cycle life over comparative examples.

### Example 1

### Preparation of Hydrogen-Absorbing Alloy

A rare-earth element, magnesium, nickel, and aluminum were mixed at a predetermined ratio, and then dissolved in an Ar gas atmosphere of an induction furnace at 1500° C. The resultant material was cooled to prepare a hydrogen-absorbing alloy ingot having a composition of Sm_{0.83}Mg_{0.17}Ni_{2.73}Al_{0.17} as shown in Table 1 below. The composition of the hydrogen-absorbing alloy was determined by an ICP analyzer. This hydrogen-absorbing alloy ingot was subjected to a heat treatment in an argon atmosphere at 950° C. for 10 hours. Thereafter, the hydrogen-absorbing alloy was mechanically pulverized in an inert atmosphere. The particle size distribution of the alloy was determined by a laser diffraction/scattering particle size analyzer, and it was found that the average particle size was 65 μm, at a weight fraction integral of 50%. The hydrogen-absorbing alloy obtained in this manner is referred to as an example alloy 1.

### Examples 2 to 7

In Examples 2 to 7, hydrogen-absorbing alloys as shown in the following Table 1 were prepared in the same manner as described in Example 1 above, except that the compositional proportions of the rare-earth elements, magnesium, nickel, and aluminum were varied. An alloy 2 of Example 2 had a composition of Sm_{0.83}Mg_{0.17}Ni_{2.93}Al_{0.17}. An alloy 3 of Example 3 had a composition of Sm_{0.86}Mg_{0.14}Ni_{2.73}Al_{0.17}. An alloy 4 of Example 4 had a composition of Sm_{0.86}Mg_{0.14}Ni_{2.93}Al_{0.17}. An alloy 5 of Example 5 had a composition of Sm_{0.89}Mg_{0.11}Ni_{2.93}Al_{0.17}. An alloy 6 of Example 6 had a composition of Gd_{0.17}Sm_{0.66}Mg_{0.17}Ni_{2.83}Al_{0.17}. An alloy 7 of Example 7 had a composition of Nd_{0.17}Sm_{0.66}Mg_{0.17}Ni_{2.83}Al_{0.17}. The compositions of these hydrogen-absorbing alloys were determined by an ICP analyzer, as in the case of Example 1.

### Comparative Examples 1 to 9

In Comparative Examples 1 to 9, hydrogen-absorbing alloys as shown in the following Table 1 were prepared in the same manner as described in Example 1 above, except that the compositional proportions of the rare-earth elements, magnesium, nickel, and aluminum were varied. An alloy A of Comparative Example 1 had a composition of Sm_{0.75}Mg_{0.25}Ni_{2.73}Al_{0.17}. An alloy B of Comparative Example 2 had a composition of Sm_{0.75}Mg_{0.25}Ni_{2.93}Al_{0. 17}. An alloy C of Comparative Example 3 had a composition of Sm_{0.89}Mg_{0.11}Ni_{2.73}Al_{0.17}. An alloy D of Comparative Example 4 had a composition of Sm_{0.83}Mg_{0.17}Ni_{3.13}Al_{0.17}. An alloy E of Comparative Example 5 had a composition of Sm_{0.89}Mg_{0.11}Ni_{3.13}Al_{0.17}. An alloy F of Comparative Example 6 had a composition of La_{0.17}Nd_{0.33}Sm_{0.33}Mg_{0.17}Ni_{3.13}Al_{0.17}. An alloy G of Comparative Example 7 had a composition of Nd_{0.89}Mg_{0.11}Ni_{3.20}Al_{0.10}. An alloy H of Comparative Example 8 had a composition of Nd_{0.8}Mg_{0.2}Ni_{2.9}Al_{0.1}. An alloy I of Comparative Example 9 had a composition of Nd_{0.75}Mg_{0.25}Ni_{2.9}Al_{0.1}. The compositions of these hydrogen-absorbing alloys were determined by an ICP analyzer, as in the case of Example 1.

Next, these hydrogen-absorbing alloys were ground in an agate mortar to prepare respective samples of the alloys. The samples were analyzed using an X-ray diffraction analyzer using a CuKα tube at a tube voltage of 50 kV, a tube current of 300 mA, and a scanning rate of 1° /min.

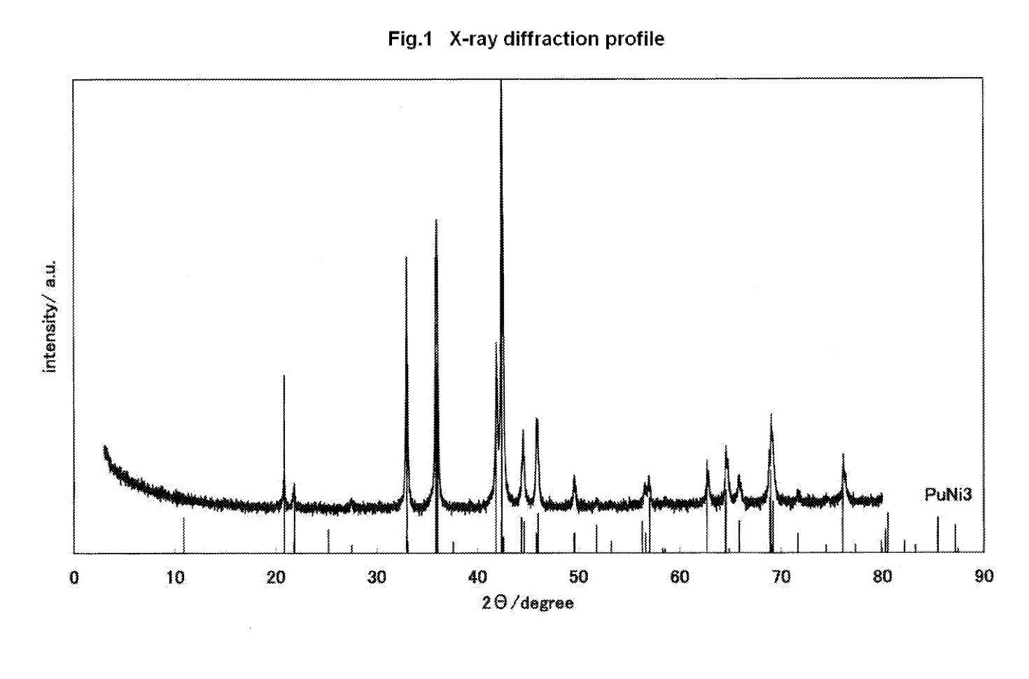

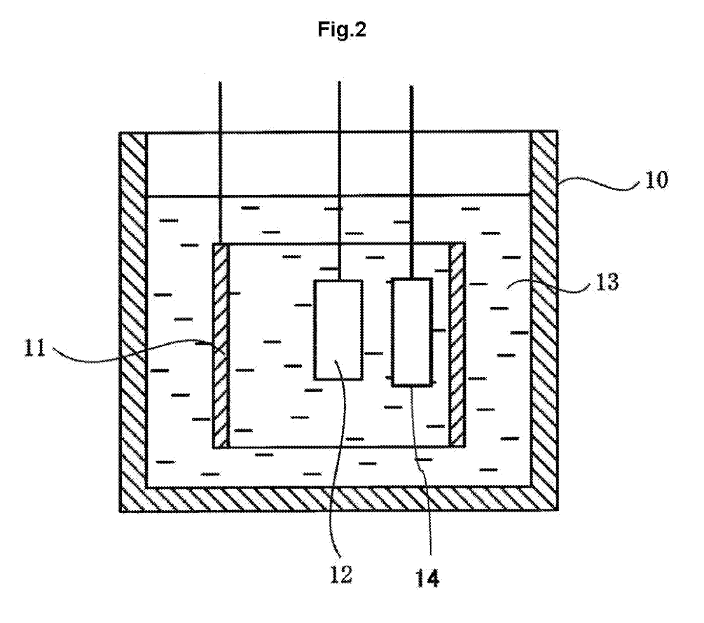

From the results obtained by the powder X-ray diffraction analysis, it was found that the alloys D to G, in which the parameter y in the general formula Ln₁₋ₓMgₓNi_{y-a-b}AlₐM_{b}, i.e., the B/A ratio, was 3.3, had a Ce₂Ni₇ type structure as its main crystal structure, while the alloys 1 to 7, A to C, and H and I, in which the parameter y in the general formula was less than 3.3, had a PuNi₃ type structure as the main crystal structure. As a typical example, FIG. 1 shows an X-ray diffraction profile of the alloy 1, which has a PuNi₃ type structure.

### [Measurement of Electrochemical Capacity]

Using the alloys 1 to 7 and the alloys A to I, pellet-shaped hydrogen-absorbing alloy electrodes were prepared in the following manner. 1 part by weight of each alloy (0.25 g) and 3 parts by weight of nickel powder (0.75 g) as a conductive agent were mixed together, and the mixture was press-formed in a pellet form, to prepare a pellet-shaped hydrogen-absorbing alloy electrode.

FIG. 2 shows a schematic view of an open-type three-electrode test cell used for measuring the electrochemical capacity. Each of the resultant pellet-shaped electrodes was used as a negative electrode 12. The negative electrode 12 was placed in a container 10 together with a sintered nickel positive electrode 11 having a sufficient electrochemical capacity for the negative electrode 12, an alkaline electrolyte solution 13 comprising a 7 mol/L KOH electrolyte solution, and a reference electrode 14 comprising a mercury oxide electrode. Thus, a three-electrode test cell was prepared. This three-electrode test cell was negative electrode capacity-limited, and had a capacity of 90 mAh.

The resultant three-electrode test cell was repeatedly charged and discharged 7 times at 25° C. under the following conditions, and the maximum capacity obtained was employed as the electrochemical capacity of the alloy. The results of the measurements for the alloys are shown in Table 1 below.

Charge-discharge Cycle Conditions

Charge: 25° C. 45 mA 170 minutes

Rest: 25° C. 10 mins.

Discharge: 25° C. 45 mA, discharged until the negative electrode potential became −0.7 V versus the reference electrode (Hg/HgO electrode)

Rest: 25° C. 20 mins.

TABLE 1

| | | Electrochemical | B/A | Main |
|---|---|---|---|---|
| | | capacity | ratio | crystal |
| | Alloy composition | (mAh/g) | (y) | structure |
| Example | Sm_{0.83}Mg_{0.17}Ni_{2.73}Al_{0.17} | 302 | 2.9 | PuNi₃ |
| alloy 1 | | | | |
| Example | Sm_{0.83}Mg_{0.17}Ni_{2.93}Al_{0.17} | 313 | 3.1 | PuNi₃ |
| alloy 2 | | | | |
| Example | Sm_{0.86}Mg_{0.14}Ni_{2.73}Al_{0.17} | 302 | 2.9 | PuNi₃ |
| alloy 3 | | | | |
| Example | Sm_{0.86}Mg_{0.14}Ni_{2.93}Al_{0.17} | 315 | 3.1 | PuNi₃ |
| alloy 4 | | | | |
| Example | Sm_{0.89}Mg_{0.11}Ni_{2.93}Al_{0.17} | 316 | 3.1 | PuNi₃ |
| alloy 5 | | | | |
| Example | Gd_{0.17}Sm_{0.66}Mg_{0.17}Ni_{2.83}Al_{0.17} | 300 | 3.0 | PuNi₃ |
| alloy 6 | | | | |
| Example | Nd_{0.17}Sm_{0.66}Mg_{0.17}Ni_{2.83}Al_{0.17} | 308 | 3.0 | PuNi₃ |
| alloy 7 | | | | |
| Comparative | Sm_{0.75}Mg_{0.25}Ni_{2.73}Al_{0.17} | 233 | 2.9 | PuNi₃ |
| alloy A | | | | |
| Comparative | Sm_{0.75}Mg_{0.25}Ni_{2.93}Al_{0.17} | 280 | 3.1 | PuNi₃ |
| alloy B | | | | |
| Comparative | Sm_{0.89}Mg_{0.11}Ni_{2.73}Al_{0.17} | 294 | 2.9 | PuNi₃ |
| alloy C | | | | |
| Comparative | Sm_{0.83}Mg_{0.17}Ni_{3.13}Al_{0.17} | 308 | 3.3 | Ce₂Ni₇ |
| alloy D | | | | |
| Comparative | Sm_{0.89}Mg_{0.11}Ni_{3.13}Al_{0.17} | 317 | 3.3 | Ce₂Ni₇ |
| alloy E | | | | |
| Comparative | La_{0.17}Nd_{0.33}Sm_{0.33}Mg_{0.17}Ni_{3.13}Al_{0.17} | 329 | 3.3 | Ce₂Ni₇ |
| alloy F | | | | |
| Comparative | Nd_{0.89}Mg_{0.11}Ni_{3.20}Al_{0.10} | 324 | 3.3 | Ce₂Ni₇ |
| alloy G | | | | |
| Comparative | Nd_{0.8}Mg_{0.2}Ni_{2.9}Al_{0.1} | 341 | 3.0 | PuNi₃ |
| alloy H | | | | |
| Comparative | Nd_{0.75}Mg_{0.25}Ni_{2.9}Al_{0.1} | 329 | 3.0 | PuNi₃ |
| alloy I | | | | |

It is seen from the results in Table 1 that the example alloys 1 to 7, which have a PuNi₃ type crystal structure as the main crystal structure, tend to show lower electrochemical capacities than the comparative example alloys D to G, which have a Ce₂Ni₇ type crystal structure as the main crystal structure. The initial electrochemical capacities of the example alloys 1 to 7 are lower because of the change in the crystal structure.

However, as will be discussed in detail below, the example alloys 1 to 7 are able to inhibit the deterioration of the electrochemical capacity that is associated with the charge-discharge cycles more effectively than the comparative alloys E to G, although they have lower initial electrochemical capacities than the comparative alloys E to G

### [Preparation of Electrodes]

0.4 parts by weight of sodium polyacrylate, 0.1 parts by weight of carboxymethylcellulose, and 2.5 parts by weight of polytetrafluoroethylene dispersion (dispersion medium: water, solid content: 60 parts by weight) were mixed with 100 parts by weight of each of the hydrogen-absorbing alloys 1 to 7 of the foregoing examples and the hydrogen-absorbing alloys A to G of the comparative examples, to prepare respective pastes. Each of the pastes was applied uniformed onto both sides of a 60 μm-thick conductive plate made of a punched metal plated with nickel. The resultant material was dried and calendered, and then cut into predetermined dimensions. Thus, hydrogen-absorbing alloy electrodes were prepared, each of which was used as a negative electrode.

Positive electrodes were prepared in the following manner. Nickel hydroxide powder containing 2.5 parts by weight of zinc and 1.0 parts by weight of cobalt was put into an aqueous solution of cobalt sulfate, and 1 mole of sodium hydroxide was gradually dropped into the mixture while agitating the mixture to cause the substances to react with each other until the pH became 11. Thereafter, the resulting precipitate was filtered, washed with water, and dried. Then, the resultant material was heat-treated in an environment in which sodium hydroxide and oxygen co-exist. Thus, a nickel hydroxide active material, the surface of which was coated with sodium-containing cobalt oxide, was obtained. Then, 95 parts by weight of the just-described nickel hydroxide active material was mixed with 3 parts by weight of zinc oxide and 2 parts by weight of cobalt hydroxide. To the mixture, 50 parts by weight of 0.2 wt % hydroxypropylcellulose aqueous solution was added. These were mixed to prepare a slurry. The resultant slurry was filled in a nickel foam having a weight per unit area of 500 g/m², then dried and compressed. Thereafter, the resultant material was cut into predetermined dimensions. Thus, a non-sintered nickel positive electrode was prepared.

A nonwoven fabric made of polypropylene was used as a separator. An alkaline electrolyte solution used was an alkaline aqueous solution containing KOH, NaOH, and LiOH—H₂O in a total amount of 30 weight % and at a weight ratio of 8:0.5:1. Using these components, cylindrical alkaline storage batteries were fabricated, each of which had a design capacity of 1500 mAh.

The fabricated batteries having the example alloys 1 to 7 are referred to as example batteries 1 to 7, respectively, and those having the comparative alloys A to I are referred to as comparative batteries A to I.

Each of the example batteries 1 to 7 and the comparative batteries A to I was charged at a current of 150 mA for 16 hours, and thereafter discharged at a current of 1500 mA until the battery voltage reached 1.0 V. This cycle was repeated 3 times to activate the batteries.

A cycle life test was conducted in the following manner. Each of the batteries was charged at a current of 1500 mA until the battery voltage reached to the maximum value and thereafter dropped by 10 mV. Each of the batteries was discharged at a current of 1500 mA until the battery voltage reached 1.0 V. This charge-discharge process was defined as 1 cycle. This charge-discharge cycle was repeated, and the number of cycles at which the discharge capacity of each battery decreased to 60% of the discharge capacity obtained at the first cycle was employed as the cycle life of the battery.

In addition, after 100 cycles of the charge-discharge process was repeated, the hydrogen-absorbing alloy was taken out from each battery, and the concentration of oxygen in the alloy was measured to determine the oxygen content of the alloy. For each of the alloys, the oxygen content of the alloy, represented as an index number relative to the comparative battery G, which is taken as 100, and the cycle life were determined. The results are shown in Table 2 below.

TABLE 2

| | | Oxygen content | |
|---|---|---|---|
| | | of alloy | Cycle life |
| | Alloy used | (Index number) | (Index number) |
| Example | Sm_{0.83}Mg_{0.17}Ni_{2.73}Al_{0.17} | 100 | 148 |
| battery 1 | | | |
| Example | Sm_{0.83}Mg_{0.17}Ni_{2.93}Al_{0.17} | 120 | 134 |
| battery 2 | | | |
| Example | Sm_{0.86}Mg_{0.14}Ni_{2.73}Al_{0.17} | 110 | 119 |
| battery 3 | | | |
| Example | Sm_{0.86}Mg_{0.14}Ni_{2.93}Al_{0.17} | 120 | 152 |
| battery 4 | | | |
| Example | Sm_{0.89}Mg_{0.11}Ni_{2.93}Al_{0.17} | 110 | 111 |
| battery 5 | | | |
| Example | Gd_{0.17}Sm_{0.66}Mg_{0.17}Ni_{2.83}Al_{0.17} | 110 | 140 |
| battery 6 | | | |
| Example | Nd_{0.17}Sm_{0.66}Mg_{0.17}Ni_{2.83}Al_{0.17} | 100 | 129 |
| battery 7 | | | |
| Comparative | Sm_{0.75}Mg_{0.25}Ni_{2.73}Al_{0.17} | 120 | 84 |
| battery A | | | |
| Comparative | Sm_{0.75}Mg_{0.25}Ni_{2.93}Al_{0.17} | 120 | 43 |
| battery B | | | |
| Comparative | Sm_{0.89}Mg_{0.11}Ni_{2.73}Al_{0.17} | 200 | 77 |
| battery C | | | |
| Comparative | Sm_{0.83}Mg_{0.17}Ni_{3.13}Al_{0.17} | 140 | 94 |
| battery D | | | |
| Comparative | Sm_{0.89}Mg_{0.11}Ni_{3.13}Al_{0.17} | 150 | 87 |
| battery E | | | |
| Comparative | La_{0.17}Nd_{0.33}Sm_{0.33}Mg_{0.17}Ni_{3.13}Al_{0.17} | 110 | 97 |
| battery F | | | |
| Comparative | Nd_{0.89}Mg_{0.11}Ni_{3.20}Al_{0.10} | 100 | 100 |
| battery G | | | |
| Comparative | Nd_{0.8}Mg_{0.2}Ni_{2.9}Al_{0.1} | 100 | 80 |
| battery H | | | |
| Comparative | Nd_{0.75}Mg_{0.25}Ni_{2.9}Al_{0.1} | 105 | 74 |
| battery I | | | |

The results shown in Table 1 clearly demonstrate that the example batteries 1 to 7 according to the invention exhibited improved cycle life over the comparative batteries A to I.

The comparative batteries F and G had almost the same oxygen contents of alloy as those of the example batteries 1 to 7 of the invention. For this reason, it is believed that the comparative batteries F and G showed poor cycle life because of the deterioration of the electrochemical capacity associated with the charge-discharge cycles, not because of the oxidative degradation of the hydrogen-absorbing alloy. In the comparative batteries F and G, the electrochemical capacity of the hydrogen-absorbing alloy lowered as the charge-discharge cycles proceeded, so the charge reserve of the negative electrode decreased, and as a consequence, hydrogen was produced easily from the negative electrode. This increased the battery internal pressure, and the battery reached the end of the battery life.

The comparative batteries A to E showed even poorer cycle life than the comparative batteries F and G The reason is believed to be as follows. The charge reserve of the negative electrode decreased as in the case of the comparative batteries F and G, and moreover, the oxidative degradation of the hydrogen-absorbing alloy was promoted as the charge-discharge cycles proceeded because the comparative batteries A to E had high oxygen contents of alloy. In particular, the comparative batteries A to C showed considerably poor cycle life. This is believed to be because the comparative batteries A to C had small electrochemical capacities as shown in Table 1 and therefore were unable to perform stable hydrogen absorption and desorption.

The comparative batteries H and I showed almost the same oxygen contents of alloy and had the same main crystal structure of the alloys as the example batteries 1 to 7 of the invention, and greater electrochemical capacities than the example batteries 1 to 7. Nevertheless, they showed considerably poorer cycle life. It is believed that, since the comparative batteries H and I used alloys that do not comprise Sm as the main component as Zr, Ti and the rare-earth including Y component, they were unable to perform stable hydrogen absorption and desorption during charge-discharge cycles. As a consequence, the electrochemical capacity of the negative electrode decreased, and the charge reserve of the negative electrode reduced.

On the other hand, the example batteries 1 to 7 of the invention contained Sm as the main component of Zr, Ti and the rare-earth including Y component in the hydrogen-absorbing alloy and had a PuNi3 structure as the main crystal structure. Therefore, the example batteries 1 to 7 were able to perform charge-discharge operations in a stable manner and inhibit oxidation of the hydrogen-absorbing alloy that is associated with the charge-discharge cycles. As a result, the cycle life of the batteries improved.

Thus, in the hydrogen-absorbing alloy, Sm is contained as the main component of Zr, Ti and the rare-earth including Y component, and the stoichiometric ratio of the amount of (Zr, Ti and rare-earth including Y element(s)+Mg) and the amount of (Ni+Al), i.e., the B/A ratio, is set to 2.5 or greater but less than 3.3. Moreover, the electrochemical capacity of the hydrogen-absorbing alloy is set at 300 mAh/g or greater. Thereby, the oxidation of the alloy associated with charge-discharge cycles can be inhibited, and at the same time, stable hydrogen absorption and desorption can be performed over a long period of time. In addition, the charge reserve of the negative electrode is prevented from decreasing. As a result, an alkaline storage battery that achieves excellent cycle life can be provided.

Only selected embodiments have been chosen to illustrate the present invention. To those skilled in the art, however, it will be apparent from the foregoing disclosure that various changes and modifications can be made herein without departing from the scope of the invention as defined in the appended claims. Furthermore, the foregoing description of the embodiments according to the present invention is provided for illustration only, and is not intended to limit the invention as defined by the appended claims and their equivalents.

What is claimed is:

1. A hydrogen-absorbing alloy represented by the general formula Ln₁₋ₓMgₓNi_{y-a-b}AlₐM_{b} (where Ln is at least one element selected from the group consisting of Zr, Ti and rare-earth elements including Y, M is at least one element selected from the group consisting of V, Nb, Ta, Cr, Mo, Mn, Fe, Co, Ga, Zn, Sn, In, Cu, Si, P, B, and Zr, 0.05≦x≦0.35, 0.05≦a≦0.30, 0≦b≦0.5, and 2.5≦y<3.3) Ln in the general formula comprises Sm as its main component, and the hydrogen-absorbing alloy has a electrochemical capacity of 300 mAh/g or greater.

2. The hydrogen-absorbing alloy according to claim 1, having a PuNi₃ type crystal structure or a CeNi₃ type crystal structure.

3. The hydrogen-absorbing alloy according to claim 1, wherein the amount of Mg in the hydrogen-absorbing alloy satisfies the expression 0.11≦x≦0.17.

4. The hydrogen-absorbing alloy according to claim 2, wherein the amount of Mg in the hydrogen-absorbing alloy satisfies the expression 0.11≦x≦0.17.

5. An alkaline storage battery comprising a positive electrode, a negative electrode, and an alkaline electrolyte solution, wherein the negative electrode comprises a hydrogen-absorbing alloy according to claim 1.

6. An alkaline storage battery comprising a positive electrode, a negative electrode, and an alkaline electrolyte solution, wherein the negative electrode comprises a hydrogen-absorbing alloy according to claim 2.

7. An alkaline storage battery comprising a positive electrode, a negative electrode, and an alkaline electrolyte solution, wherein the negative electrode comprises a hydrogen-absorbing alloy according to claim 3.

8. An alkaline storage battery comprising a positive electrode, a negative electrode, and an alkaline electrolyte solution, wherein the negative electrode comprises a hydrogen-absorbing alloy according to claim 4.
